(19) United States
(12) Patent Application Publication
(10) Pub. No.: US 2015/0234664 A1
(43) Pub. Date: Aug. 20, 2015

(54) MULTIMEDIA DATA PROCESSING METHOD AND MULTIMEDIA DATA PROCESSING SYSTEM USING THE SAME

(71) Applicant: Samsung Electronics Co., Ltd., Suwon-si (KR)

(72) Inventors: Hyo-Eun Kim, Hwaseong-si (KR); Chang-Hyo Yu, Yongin-si (KR); Seok-Hoon Kim, Suwon-si (KR); Yongha Park, Seongnam-si (KR); Kilwhan Lee, Seoul (KR)

(21) Appl. No.: 14/618,124

(22) Filed: Feb. 10, 2015

(30) Foreign Application Priority Data
Feb. 14, 2014 (KR) 10-2014-0017396

(51) Int. Cl. G06F 9/38; G06F 12/08; G06F 9/30

(52) U.S. Cl. CPC G06F 9/3861; G06F 9/30043; G06F 12/0875; G06F 2212/452

(57) ABSTRACT

A multimedia data processing method is provided which includes providing a conflict detection unit at a load/store pipeline unit; generating, by the conflict detection unit, speculative conflict information, which is used to predictively determine whether an address of a load/store instruction of a current thread causes a conflict miss before a cache access operation is performed by performing a history search for load/store instruction addresses of previous threads without referring to a cache memory; and storing information of the current thread directly in a standby buffer without an execution of the cache access operation in response to the generated speculative conflict information indicating the conflict miss.

### CROSS-REFERENCE TO RELATED APPLICATIONS

A claim for priority under 35 U.S.C. §119 is made to Korean Patent Application No. 10-2014-0017396 filed Feb. 14, 2014 at the Korean Intellectual Property Office, the entire contents of which are hereby incorporated by reference.

### BACKGROUND

The inventive concepts described herein relate to a multimedia data processing field, and more particularly, relate to a multimedia data processing system and method.

A data processing system contains at least one processor, for example, a central processing unit (CPU). The data processing system may include but not be limited to other processors, which are used for various types of specialized processing, such as a graphics processing unit (GPU).

For example, the GPU is designed for graphic processing operations. The GPU, in general, includes a plurality of processing units that are suitable for executing the same command on parallel data streams like data-parallel processing. In general, a CPU may act as a host or a control processor and hand off specialized functions, e.g., graphic processing, to other processors, e.g., a GPU.

Hybrid cores with characteristics of the CPU and GPU have been proposed for general-purpose GPU (GPGPU) styling computing. A GPGPU style of computing executes a control code using the CPU and offloads performance-critical data-parallel code to the GPU.

Co-processors including a CPU and GPU access a supplemental memory, e.g., graphic memory, sometimes when executing processing tasks. The co-processors are optimized to execute a three-dimensional graphic operation or related high-processing operations to support applications such as video games and CAD (Computer Aided Design).

Conflict misses caused by multiple redundant loads on the same data or adjacent data in the GPU may lower overall performance, and often occur in multimedia applications.

### SUMMARY

One aspect of embodiments of the inventive concept is directed to provide a multimedia data processing method comprising providing a conflict detection unit at a load/store pipeline unit; generating, by the conflict detection unit, speculative conflict information, which is used to predictively determine whether an address of a load/store instruction of a current thread causes a conflict miss before a cache access operation is performed by a history search for load/store instruction addresses of previous threads without referring to a cache memory; and storing information of the current thread directly in a standby buffer without an execution of the cache access operation in response to the generated speculative conflict information indicating the conflict miss.

In some embodiments, the speculative conflict information is generated in response to associative information of the cache memory and a given time window of the history search.

In some embodiments, the speculative conflict information is generated by comparing an address of the load/store instruction of the current thread with an address of the load/store instruction of the previous threads obtained from the history search.

In some embodiments, the addresses of the load/store instructions of the previous threads include index information and tag information, and the index and tag information of the addresses is stored in a register for the history search in a history file form during a user-defined time interval.

In some embodiments, the speculative conflict information is generated prior to an access operation of a cache tag memory for detection of an actual conflict miss, and wherein the method further comprises: comparing an address of a load/store instruction of a current thread with an address of a load/store instruction of the previous threads obtained from the history search; counting addresses that have the same index as the load/store instruction of the current thread and that exist in addresses of load/store instructions of the previous threads, wherein in response to a determination that the indexes of the addresses are equal to one another, the method further comprises: increasing a count value when a tag of the current address is determined to be different from each other in relation to tags of the previous addresses; and performing an invalid counting operation when the tag of the current address is equal to a tag of a previous address; and determining a generation of the speculative conflict information when a counting result value exceeds a given associative value of the cache memory.

In some embodiments, when a determination is made that the address of the load/store instruction of the current thread is a virtual address, the speculative conflict information is detected at the beginning of the load/store pipeline unit prior to a detection of an actual conflict miss.

In some embodiments, the speculative conflict information is provided to a thread dispatcher of a graphics processing unit (GPU) to control a thread level flow.

Another aspect of embodiments of the inventive concept is directed to a multimedia data processing system comprising a load/store pipeline unit including: a conflict detection unit that generates speculative conflict information that predictively indicates whether a current load/store instruction causes a conflict with respect to previously issued load/store instructions prior to a cache memory access operation is performed; a standby buffer that temporarily stores missed threads upon a generation of a cache miss operation; and a cache memory that stores data for load/store pipeline processing. The system further comprises a thread control unit that performs a flexible thread level flow control using the speculative conflict information generated by the conflict detection unit.

In some embodiments, when the conflict detection unit sets a speculative conflict detection to an ON mode, the thread control unit controls an out-of ordering of threads to be issued in the future using the speculative conflict information.

In some embodiments, when the speculative conflict information is generated, the load/store pipeline unit does not perform subsequent operations including a cache access operation, a data request operation, and a cache replace operation to prevent a future conflict miss.

In some embodiments, the conflict detection unit compares an address of a load/store instruction of a current thread with addresses of load/store instructions of previous threads obtained from a register for a history search.

In some embodiments, in response to comparing the address of the load/store instruction of the current thread with the addresses of the load/store instructions of the previous threads, the conflict detection unit counts addresses that have the same index as the address of the load/store instruction of the current thread and exist in addresses of load/store instructions of previous threads, and wherein a determination is made that if the indexes of the addresses are equal to one another, then the conflict detection unit increases a count value when tags of the current previous addresses, respectively, are determined to be different from each other, the conflict detection unit performs an invalid counting operation when the tag of the current address is equal to a tag of a previous address, and the conflict detection unit generates the speculative conflict information when a counting result value exceeds a given associative value of the cache memory.

In some embodiments, the multimedia data processing system further comprises an address generation unit that converts a virtual address of a load/store instruction of a current thread into a physical address and provides the physical address to the conflict detection unit.

In some embodiments, the conflict detection unit operates selectively according to a user control or a hardware control.

In some embodiments, the system is formed of a system-on-chip.

Another aspect of embodiments of the inventive concept is directed to a pipeline unit of a graphics processor, comprising: a conflict detection unit that generates speculative conflict information for predictively determining whether an address of a load/store instruction of a current thread causes a conflict miss before a cache access operation is performed; and a standby buffer that stores information related to the current thread absent an execution of the cache access operation in response to the generated speculative conflict information.

In some embodiments, the pipeline unit further comprises a register that stores previous load/store instructions.

In some embodiments, the conflict detection generates the speculative conflict information by comparing an address of the current load/store instruction with addresses of the previous load/store instructions stored in the register.

In some embodiments, the conflict detection unit sets a speculative conflict detection to an ON mode, and, in response, the conflict detect unit communicates with a thread control unit which controls an out-of ordering of threads to be issued in the future using the speculative conflict information.

In some embodiments, the speculative conflict information is used for predictively determining whether the address of the load/store instruction of the current thread causes a conflict miss before the cache access operation is performed by a history search for load/store instruction addresses of previous threads without referring to a cache memory.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a schematic block diagram of a multimedia data processing system applied to embodiments of the inventive concept;

FIG. 2 is a configuration block diagram of a graphics processing unit shown in FIG. 1, according to an embodiment of the inventive concept;

FIG. 3 is a detailed block diagram of a load/store pipeline unit shown in FIG. 2, according to an embodiment of the inventive concept;

FIG. 4 is a detailed block diagram of a load/store pipeline unit shown in FIG. 2, according to another embodiment of the inventive concept;

FIG. 5 is an address format diagram of a load/store instruction according to an embodiment of the inventive concept;

FIG. 6 is an operational flow chart of a thread control unit shown in FIG. 2, according to an embodiment of the inventive concept;

FIG. 7 is an operational flow chart of a load/store pipeline unit shown in FIG. 2, according to an embodiment of the inventive concept;

FIG. 8 is a diagram schematically illustrating a typical example of a conflict miss in a single thread;

FIG. 9 is a diagram showing an effect capable of solving conflict miss described with reference to FIG. 8;

FIG. 10 is a diagram showing a typical example of conflict miss at a simultaneous multi-threading environment;

FIG. 11 is a diagram showing an effect capable of solving conflict miss described with reference to FIG. 10;

FIG. 12 is configuration block diagram of a multimedia data processing system according to another embodiment of the inventive concept;

FIG. 13 is a block diagram schematically illustrating an application applied to a multimedia device, in accordance with embodiments of the present inventive concepts;

FIG. 14 is a block diagram schematically illustrating an application applied to a mobile device, in accordance with embodiments of the present inventive concepts;

FIG. 15 is a block diagram of a computing device, in accordance with embodiments of the present inventive concepts; and

FIG. 16 is a block diagram of a digital processing system, in accordance with embodiments of the present inventive concepts.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Embodiments disclosed therein may include their complementary embodiments. Note that details associated with a data processing operation using a GPU cache, a cache hit/miss generation operation, and internal software may be skipped to prevent the inventive concept from becoming ambiguous.

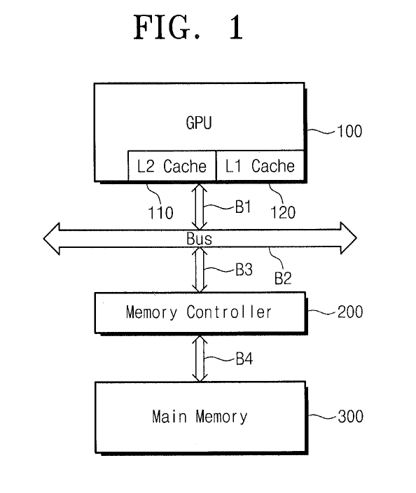

FIG. 1 is a schematic block diagram of a multimedia data processing system applied to the inventive concept.

Referring to FIG. 1, a multimedia data processing system includes a graphics processing unit (GPU) 100, a memory controller 200, and a main memory 300.

The GPU 100 includes an L1 cache 120 and an L2 cache 110 to process multimedia data.

The GPU 100 is connected to a system bus B2 via a bus B1.

The memory controller 200 is connected to the system bus B2 via a bus B3.

The memory controller 200 is connected to the main memory 300 via a bus B4.

Multimedia data stored in the main memory 300 may include image data or red green blue (RGB) pixel data.

The L1 cache 120 and the L2 cache 110 may be used to store a portion of multimedia data stored in the main memory 300. Thus, at a data processing operation, the GPU 100 first accesses the L1 cache 120 to determine whether requested data exists in the L1 cache 120. If accessing the L1 cache 120 results in a cache hit, then the GPU 100 directly fetches data stored in the L1 cache 120 without accessing the L2 cache 110. When accessing the L1 cache 120 results in a cache miss, then the GPU 100 accesses the L2 cache 110. A L2 cache hit occurs when requested data exists in the L2 cache 110. In this case, the GPU 100 directly fetches data stored in the L2 cache 110 without accessing the main memory 300.

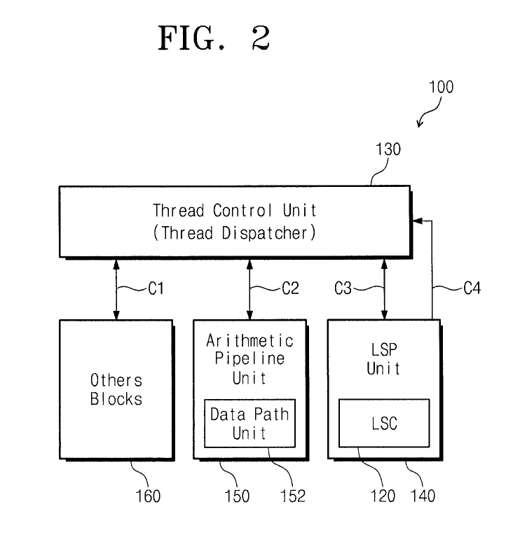

FIG. 2 is a configuration block diagram of the GPU 100 shown in FIG. 1, according to an embodiment of the inventive concept.

The GPU 100 includes a thread control unit 130, or thread dispatcher, a load/store pipeline (LSP) unit 140, an arithmetic pipeline unit 150, and one or more other blocks 160.

The arithmetic pipeline unit 150 is connected to the thread control unit 130 via a line C2 constructed to exchange electrical signals such as data between the arithmetic pipeline unit 150 and the thread control unit 130. The arithmetic pipeline unit 150 performs an arithmetic operation on multimedia data. A line C1 extends between the thread control unit 130 and the other blocks 160 to exchange electrical signals such as data, control, and so on.

The load/store pipeline unit 140 loads or stores multimedia data in response to a load/store instruction.

The load/store pipeline unit 140 is connected to the thread control unit 130 via a line C3 constructed to exchange electrical signals such as data between the load/store pipeline unit 140 and the thread control unit 130, and includes a load store cache (LSC) memory 120. The LSC memory 120 corresponds to the L1 cache 120 shown in FIG. 1, for example.

The arithmetic pipeline unit 150 has a data path unit 152.

The load/store pipeline unit 140 produces latent speculative information SCDI according to an embodiment of the inventive concept. The load/store pipeline unit 140 may include an internal register for a history search or may perform a latch operation using a program. The register may be implemented with, but not limited to, a first in first out (FIFO) memory and store addresses of previous load/store instructions. The addresses may include index information and tag information, respectively.

The thread control unit 130 receives the speculative conflict information SCDI from the LSP unit 140 via a line C4 constructed to exchange electrical signals such as data between the LSP unit 140 and the thread control unit 130.

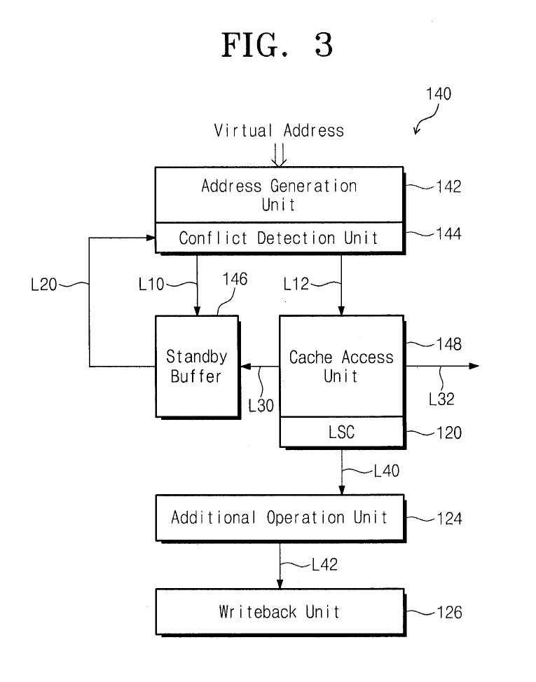

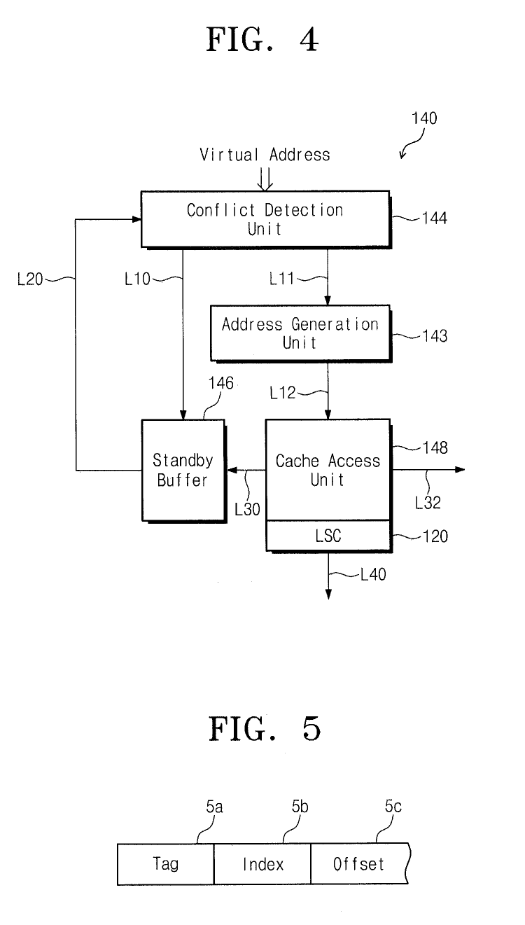

The speculative conflict information SCDI may be information that predictively indicates whether a current load/store instruction causes a conflict with respect to previously issued load/store instructions. The speculative conflict information SCDI may be generated by a conflict detection unit 144 shown in FIG. 3 or 4. The speculative conflict information SCDI may be produced by comparing an address of a current load/store instruction with addresses of previous load/store instructions stored in the register for a history search before a cache memory access operation.

In exemplary embodiments, the term “frequently used load/store” may include “load and store” and “load or store”.

The thread control unit 130 performs a flexible thread level flow control using the speculative conflict information SCDI that the conflict detection unit 144 produces. For example, the speculative conflict information SCDI makes it possible to control out-of-ordering of threads to be issued more flexibly.

Also, the speculative conflict information SCDI enables a miss rate of a cache accessing operation to be reduced, thereby improving a processing performance of multimedia data. Also, processing performance of GPU is improved by latency saving.

FIG. 3 is a detailed block diagram of the LSP unit 140 shown in FIG. 2, according to an embodiment of the inventive concept.

Referring to FIG. 3, the LSP unit 140 comprises an address generation unit 142, a conflict detection unit 144, a standby buffer 146, a cache access unit 148, and a LSC memory 120. The LSP unit 140 can further include an additional operation unit 124 and a writeback unit 126.

The address generation unit 142 converts a virtual address or, a logical address into a physical address.

Before a cache access operation is carried out, the conflict detection unit 144 generates speculative conflict information predictively indicating whether a current load/store instruction causes a conflict with respect to previously issued load/store instructions based on a history search. In doing so, the conflict detection unit 144 does not access or otherwise refer to the cache memory 120.

The speculative conflict information may be based on associative information of the cache memory 120 and a given time window of the history search. For example, as a value of the associative information becomes great, the probability that a conflict miss of the speculative conflict information occurs may decrease. Also, where the time window is wide, that is, as a number of addresses of load/store instructions on previous threads have been stored, the probability that conflict miss of the speculative conflict information occurs may increase.

The speculative conflict information may be generated by comparing an address of a load/store instruction of the current thread with addresses of load/store instructions of previous threads.

In more detail, each of the addresses of the load/store instructions of the previous threads has index information and tag information, and the index and tag information of the addresses is stored in the register for a history search in the history file form during a user-defined time interval.

The speculative conflict information may be generated before an access to a cache tag memory for detection of an actual conflict miss. An address of a load/store instruction of a current thread is compared with addresses of load/store instructions of previous threads obtained from the history search.

In detail, the comparison may be made to count addresses that have the same index as the load/store instruction of the current thread and are included in addresses of load/store instructions of previous threads.

Tags of current and previous addresses are compared when indexes are equal to each other. When a determination is made from the comparison that tags are different from each other, increasing counting is made. When tags are equal to each other, invalid counting is made. The invalid counting means that a counting value does not increase. Where the counting result value exceeds a given associative value of the cache memory, generation of the speculative conflict information is determined to be conflict miss.

As a result, addresses, such as each address including index information and tag information of load/store instructions of previous threads, may be stored in the register (e.g., FIFO memory) in the history file form during the user-defined time interval. In exemplary embodiments, therefore, cache tag information of the cache memory is not referred upon detection of the speculative conflict information. In other words, a register or the like stores addresses of load/store instructions associated with previously passed threads in the history file form. This may mean that previous addresses are not fetched by accessing the cache tag memory.

As described above, the speculative conflict information may be detected through the history search referring to the register, not a cache TAG memory.

In FIG. 3, if the speculative conflict information that the conflict detection unit 144 generates indicates a speculative conflict miss, then information of a current thread is transferred directly to the standby buffer 146 via a line L10, without a cache access operation that the cache access unit 148 performs.

Here, the speculative conflict information indicates whether a load/store instruction of a current thread causes the speculative conflict miss. As a result, the speculative conflict information means that predictive detection for predicting whether conflict miss will occur henceforth. In general cache sources, detection information of actual conflict miss and speculative conflict information may have different meanings.

At an actual cache access operation, index information of an address is used to search cache tag data of a cache tag memory unit. When searched, cache tag data is compared with tag information of an address of a load/store instruction. When the cache tag data corresponds to the tag information, a cache hit is generated. When the cache tag data does not correspond to the tag information, a cache miss is generated.

In exemplary embodiments, the speculative conflict information is detected by performing the history search on the register before a cache access operation, that is, a cache tag comparison step. Thus, the speculative conflict information is detected at the beginning of an operation of the load/store pipeline unit 140 before conflict miss is actually detected.

Where the speculative conflict information that the conflict detection unit 144 generates indicates a speculative conflict miss, thread information is instantly stored in the standby buffer 146 without an execution of a cache access and data request/replace operations.

In a typical operation of a load/store pipeline unit, a cache access operation must be performed every thread to determine the cache miss or the cache hit. In particular, in case of the cache miss, after the cache access operation, requested data may be requested directly to next-level memory layers.

Unlike the above description, the load/store pipeline unit 140 according to embodiments of the inventive concepts may save cache access/request power/latency on threads detected as speculative conflicts. The reason is that upon detection of the speculative conflict, thread information is provided directly to the standby buffer 146. Also, the load/store pipeline unit 140 according to embodiments of the inventive concept may prevent conflict misses, which are to be caused due to following instructions, by utilizing data coherency and temporarily restricting on-demand data requests.

Where the speculative conflict information that the conflict detection unit 144 generates is not indicative of speculative conflict miss, i.e., a non-speculative conflict miss, current thread information is provided to the cache access unit 148 via a line L12. At this time, the cache access unit 148 accesses the load store cache memory 120. If an access result indicates a cache miss, the cache access unit 148 issues a data request to an L2 cache 110 or an L3 cache, i.e., a system level cache memory, or to an external memory via a line L32. If an access result indicates a cache hit, the cache access unit 148 provides the standby buffer 146 with missed thread information via a line L30.

Data stored in the cache memory 120 is output via a line L40 when an access result indicates the cache hit. The additional operation unit 124 and the writeback unit 126 can process the data output when an access result indicates the cache hit.

A thread is transferred via a normal load/store pipeline when an applied load/store instruction is detected as a non-speculative conflict.

The speculative conflict information may be detected at the beginning of an execution step of a load/store pipeline, thereby reducing power and/or latency necessary for following processing.

If an address mode of the cache memory 120 is addressing having a physical address, then the speculative conflict information is detected just before an actual cache access operation, unlike the case where conflict detection logic exists at a lower portion. In this case, before a load/store instruction is actually executed, there is performed a separate instruction that is different from a load/store instruction that is detected as speculative conflict. For example, to execute independent operations, the thread control unit 130 may treat a thread as a virtual thread until the thread is reissued from the standby buffer 146.

FIG. 4 is a detailed block diagram of a LSP unit shown in FIG. 2, according to another embodiment of the inventive concept.

The LSP unit 140 includes a conflict detection unit 144, an address generation unit 143, a standby buffer 146, a cache access unit 148, and a LSC memory 120

The standby buffer 146 temporarily stores missed threads when speculative conflict information directs a conflict miss.

The load store cache memory 120 stores a part of data stored in a main memory 300 for load/store pipeline processing.

The conflict detection unit 144 receives a virtual address and generates speculative conflict information before a cache access operation by comparing addresses as described above.

If an address mode of the LSC memory 120 is addressing having a virtual address as shown in FIG. 4, then a detection on the speculative conflict information is instantly performed before an actual physical address is generated. In this case, the speculative conflict information may be used within the thread control unit 130 directly for more flexible thread level flow control. For example, the thread control unit 130 performs out-of ordering of threads within a thread pool using the speculative conflict information detected to prevent future conflict misses. Here, the out-of ordering may mean that assuming that 1^{st} to 3^{rd} threads of 1^{st} to 10^{th} threads are dependent one another, 4^{th} to 10^{th} threads independent from the 1^{st} thread are first processed upon detection of the speculative conflict information on the 1^{st} thread. Here, that the 1^{st} to 3^{rd} threads are dependent one another may indicate that the 3^{rd} thread necessitates a result obtained by executing the 2^{nd} thread, and that the 2^{nd} thread necessitates a result obtained by executing the 1^{st} thread.

In FIG. 3 or 4, a line L20 may refer to a line that transfers thread information stored in the standby buffer 146 to the conflict detection unit 144.

In FIG. 4, if the speculative conflict information directs a speculative conflict miss, then current thread information is provided directly to the standby buffer 146 via a line L10 without passing through the address generation unit 143.

In FIG. 2, the speculative conflict information may be applied to the thread control unit 130 via a line L4.

FIG. 5 is an address format diagram of a load/store instruction according to an embodiment of the inventive concept.

Referring to FIG. 5, an address for a memory data request to be provided from a processor, e.g., a CPU, includes a tag field 5a, an index field 5b, and an offset field 5c.

Tag information is stored in the tag field 5a, and the index field 5b is used to store index information that is used to search a cache line. The offset field 5c is used to store offset information that appoints hoped-for or predictive data within a cache line. The address shown in FIG. 5 may be stored in a cache memory or the like.

In exemplary embodiments, addresses of previous threads may be stored in a register, for example, at the LSP unit 140, where a history search in a history form can be performed. Each address may include index information and tag information.

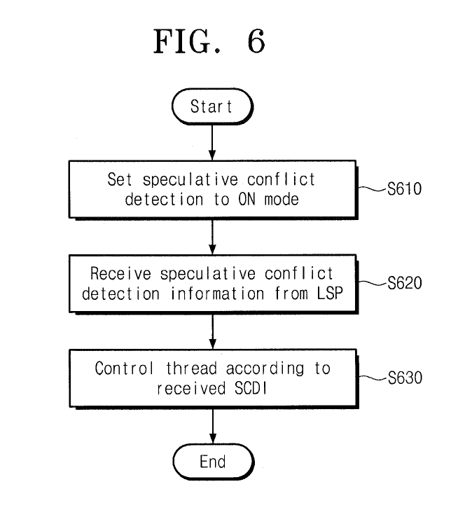

FIG. 6 is an operational flow chart of a thread control unit 130 shown in FIG. 2, according to an embodiment of the inventive concept.

Referring to FIG. 6, in step S610, speculative conflict detection is set to an ON mode, for example, via line C3. Here, a conflict detection unit 144 of FIG. 3 or 4 may be driven selectively by an internal or external control. That is, a CPU may activate the conflict detection unit 144 if speculative conflict information is used for processing multimedia data is advantageous.

In step S620, a thread control unit 130 receives the speculative conflict information from an LSP unit 140. The thread control unit 130 performs a thread dispatch operation (e.g., out-of ordering) more flexibly using the speculative conflict information SCDI. This may correspond to step S630 in which the thread control unit 130 controls threads according to the received speculative conflict information SCDI.

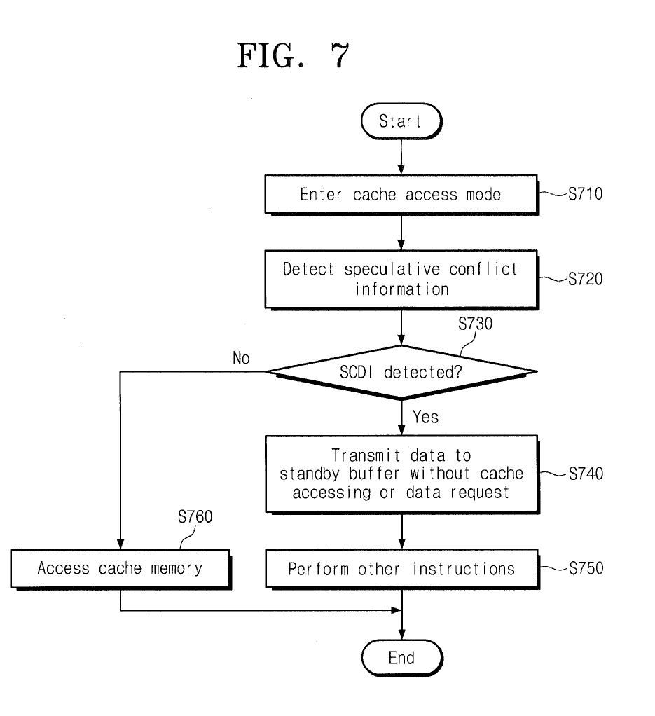

FIG. 7 is an operational flow chart of a load/store pipeline unit shown in FIG. 2, according to an embodiment of the inventive concept.

Referring to FIG. 7, in step S710, an entrance to a cache access mode is made for a threshold operation. In step S720, speculative conflict information is detected prior to the cache access operation. The speculative conflict information may be detected by performing the above-described address comparing operation using a physical address or a virtual address.

If at decision diamond step S730 the speculative conflict information is detected to be a conflict miss, then the method proceeds to step S740, in which information of a current thread is sent to a standby buffer 146 without a cache access or data request. Afterwards, other instructions may be executed.

If at decision diamond step S730 non-speculative conflict information is detected, then the method proceeds to step S760, in which an operation of accessing a cache memory commences.

As described above, if the speculative conflict information is first detected, then information of a current thread is sent to the standby buffer 146 or the cache memory is accessed. Since a miss rate is reduced at the cache accessing operation, performance of multimedia data processing is improved. Also, processing performance of GPU is bettered through power, energy, and latency saving.

Now will be described a 4-way set-associative cache, for example, illustrating effects of speculative conflict information according to an embodiment of the inventive concept.

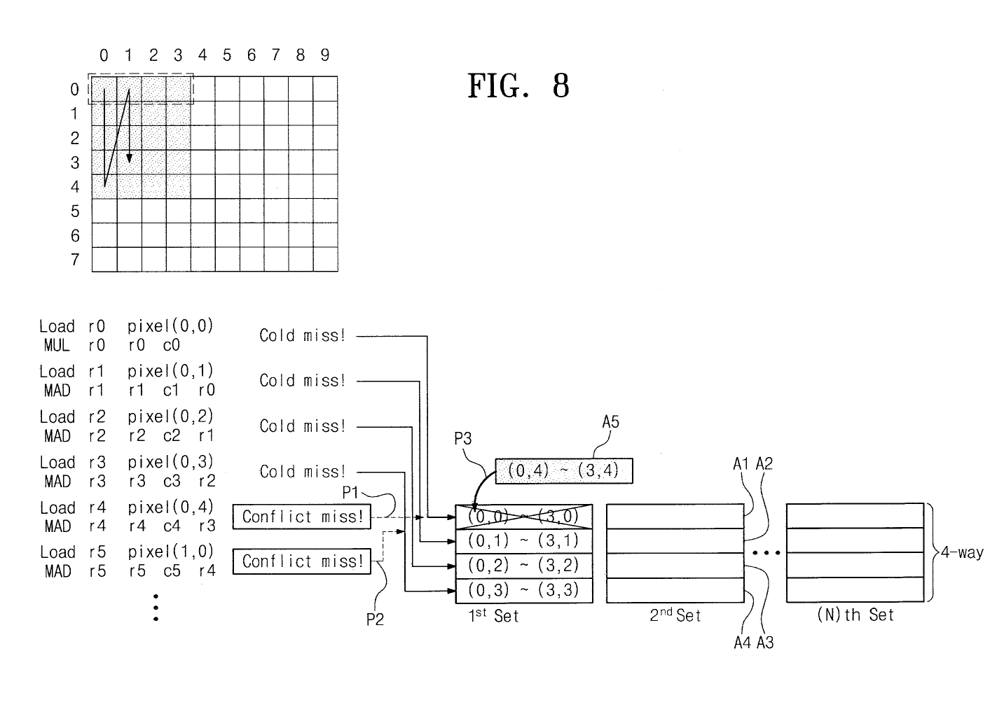

FIG. 8 is a diagram schematically illustrating a typical example of a conflict miss in a single thread.

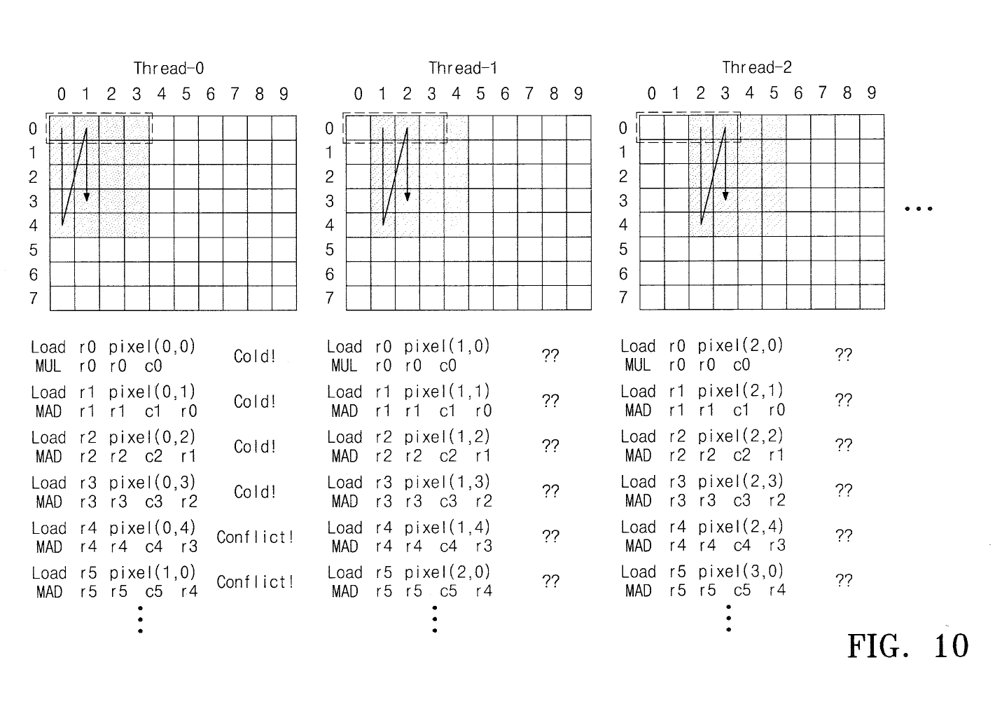

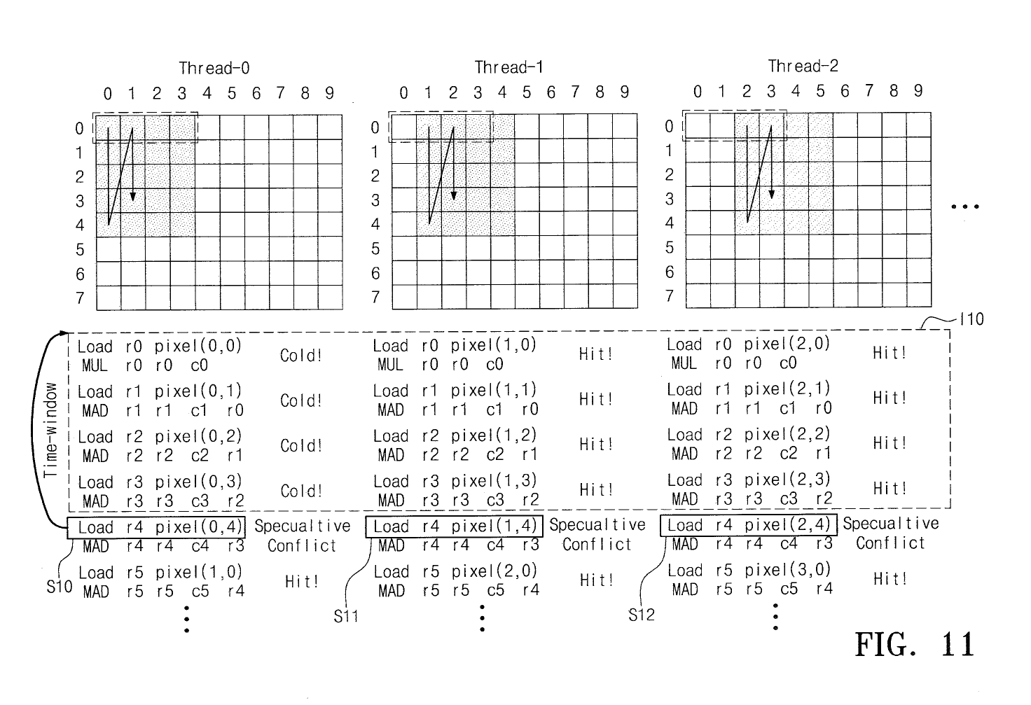

Also, FIG. 10 is a diagram schematically illustrating a typical example of a conflict miss at a simultaneous multi-threading environment.

A typical multimedia processor may consist of a thread dispatcher, an arithmetic pipeline unit, i.e., parallel ALU operating with multiple processing elements, a load/store pipeline, i.e., LSP loading/storing requested data from/at memory layers, unit, and a variety of functional pipelines such as other pipelines.

Since such functional pipelines perform allocated tasks in parallel, a simultaneous multi-threading technique may be widely used to process multimedia data. The thread dispatcher may support an overall thread level flow control.

An LSP may consist of an address generation unit for converting a virtual address into a physical address, a cache access unit for checking cache hit/miss and performing tag memory accessing and tag comparison, a load/store cache (LSC) acting as cache storage, a standby buffer for temporarily retaining missed threads, and supplemental operation modules (e.g., write-back).

In environments where requested data does not exist in the LSC, that is, in case of cache miss, a thread is sent to the standby buffer. At this time, data is requested to next-level memory layers.

In case requested data exists in the LSC, that is, in case of cache hit, data is loaded directly from the LSC. Afterwards, next operations are performed.

At a typical LSP operation, data lately loaded on the LSC may be replaced with an incoming load instruction (conflict miss) within a short time. The LSC loaded with data when following load instructions may require currently replaced data. In general multimedia applications, however, a probability that recently loaded data is again used may be high. The reason is that spatial/temporal data coherency among multiple threads (even a single thread) exists. Thus, conflict misses caused by multiple redundant loads on the same data lower the whole performance and frequently occur in multimedia applications.

In a single thread, as illustrated in FIG. 8 for example, a 5×5 Gaussian filtering operation may need at least a 5-way set associative cache to minimize conflict miss within a single working set, e.g., an area formed of 5×5 pixels. If the LSC is implemented with a 4-way set associative cache, a 5^{th} load instruction (loading of a pixel (0, 4)) may be loaded on a data chuck (0, 4) to (3, 4) as marked by a symbol “A5”. In this case, based on an LRU (least recently used: i.e., the oldest data), a conflict miss is caused as marked by a symbol “P1”, and pre-loaded data (0, 0) to (3, 0) is replaced. Unfortunately, a 6^{th} load instruction may require previous replaced data (0, 0) to (3, 0). This may cause, although unnecessary, a conflict miss or a reloading of data from the L2 cache resulting in lower performance.

As a result, at a typical operation, a conflict miss may occur as marked by symbols “P1” and “P2”.

Referring to FIG. 10, at a simultaneous multi-threading (SM) environment, multiple threads continue to perform an LSP operation according to a time interleaved manner. In particular, in multimedia applications, multiple threads may, in general, need spatially coherent data as illustrated in FIG. 10. In this case, multiple threads belonging to a given time window share a single LSC. Data that is replaced due to conflict miss in a thread causes successive conflict misses on other threads under the SMT environment. As a result, in the example illustrated in FIG. 10, successive conflict misses occur at threads Thread-1 and Thread-2. These issues may be more critical at general-purpose multimedia applications. The reason is that performance is sharply deteriorated due to a lack of development of spatial/temporal data coherency.

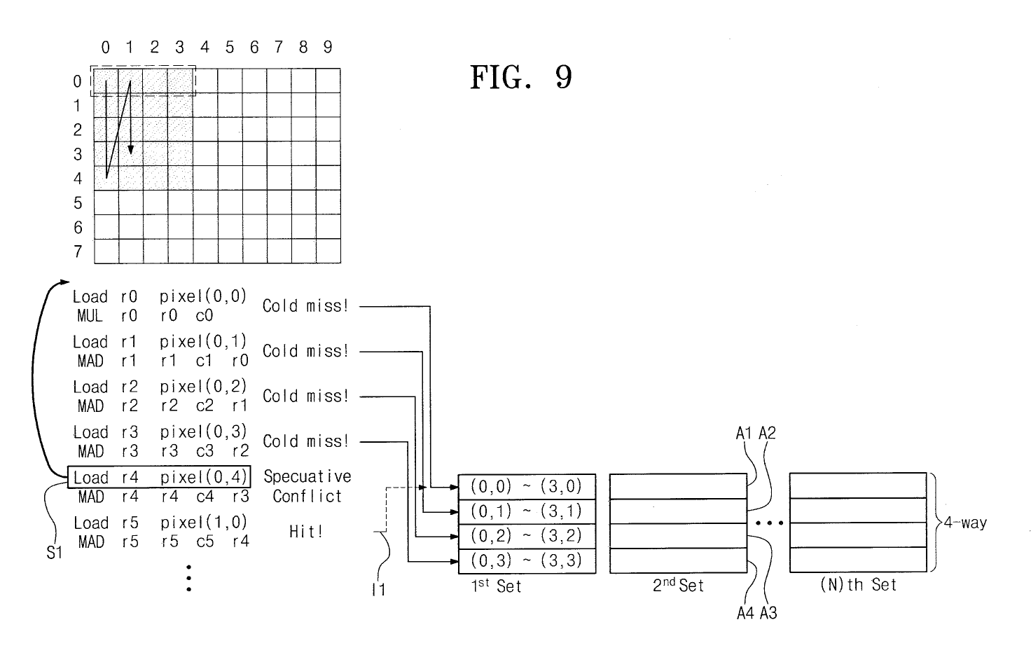

FIG. 9 is a diagram showing an effect of the inventive concept capable of solving conflict miss described with reference to FIG. 8.

FIG. 11 is a diagram showing an effect of the inventive concept capable of solving conflict miss described with reference to FIG. 10.

Now will be described FIG. 9 in relation to FIG. 8.

In FIG. 9, when performing an LSP operation via a normal LS pipeline, an LSB unit 140 detects whether a 5^{th} load instruction causes speculative conflict miss. That is, at an operation marked by a symbol “S1” of FIG. 9, speculative conflict information is detected. At the beginning of an LSP, the LSP unit 140 detects speculative conflict information prior to an actual cache access/request operation. Therefore, it is possible to prevent unnecessary following operations and a future conflict miss due to a 6^{th} load instruction that requests previously load data within a given time window (a symbol I1). In FIG. 9, since speculative conflict information is detected as marked by a symbol “S1”, an operation of replacing data as marked by a symbol “P1” of FIG. 8 does not need to be performed. Information of a current thread is transferred instantly to a standby buffer 146. An arrow extending upward from the symbol “S1” provides an indication to search a history of previously issued load/store instructions.

Now will be described FIG. 11 in relation to FIG. 10.

At the SMT environment, different threads that run within a given time window may prevent unnecessary conflict misses. Within at least a given time window, threads detected as speculative conflicts may be reissued in the future without causing an actual conflict miss. Therefore, previously loaded data may be freely used by all threads running within a given time window. In FIG. 11, if speculative conflict information is produced as marked by symbols “S10”, “S11”, and “S12”, then information of corresponding threads are transferred, and then reissued.

Thus, as understood from a reference area I10, it is possible to prevent successive conflict misses that are generated with respect to following threads Thread-1 and Thread-2.

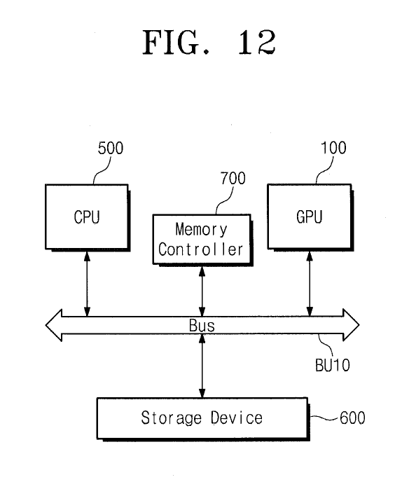

FIG. 12 is configuration block diagram of a multimedia data processing system according to another embodiment of the inventive concept.

Referring to FIG. 12, a multimedia data processing system includes a CPU 500, a GPU 100, a memory controller 700, a system bus BU10, and a storage device 600,

In FIG. 12, the storage device 600 can correspond to a main memory 300 of FIG. 1, and the memory controller 700 can correspond to a memory controller 200 of FIG. 1. The GPU 100 can correspond to a GPU 100 of FIG. 1. Also, the CPU 500 may be a processor that issues a load/store instruction.

In exemplary embodiments, detection of speculative conflict information may be applied to both a load instruction and a store instruction.

An LSP unit of the GPU 100 shown in FIG. 12 may include a conflict detection unit.

The conflict detection unit may determine whether within a given time window, a current load instruction causes a conflict with respect to previously issued load instructions. In other words, an LSP unit predictively determines whether a current load instruction causes speculative conflict miss, before an actual address step of a cache memory. If an applied load instruction is detected as speculative conflict through comparison between addresses including index information and tag information on current and previous threads, a thread is sent directly to a standby buffer without the performance of cache access and data request/replace operations.

If an applied load instruction is detected as non-speculative conflict, then a thread is transferred to a normal LSP.

Speculative conflict may be detected in an early step of the whole load/store pipeline, thereby saving power/latency on following processing. If an address mode of LSC is addressing having a physical address, then the speculative conflict information is detected before an actual cache access operation. In this case, a separate instruction is provided that is different from a load/store instruction detected as a speculative conflict. For example, to perform independent operations, a thread dispatch unit produces and uses a virtual thread as a thread until the thread is reissued from a standby buffer.

In accordance with some embodiments of the inventive concept, thus, it is possible to reduce a miss rate and improve performance. A speculative conflict detection operation of an LSP reduces a cache miss rate and further reduces conflict misses that cannot be prevented by a conventional LSP. The LSP increases reusability of previously loaded data and temporarily prevents cache replacement due to conflict misses. The whole processing performance is bettered by using for example, developing, spatial/temporal data coherency. Also, the above-described technique is more effective in general multimedia applications.

Also, a power/energy/latency saving effect is obtained through an embodiment of the inventive concept.

Since the LSP temporarily stops a speculative conflict thread at the beginning of the LSP, consumed power/energy/latency is saved and subsequent operations such as cache access and data request/replace operations are not required. Further, a plurality of threads to be processed under the SMT environment may exist. Therefore, a pipeline stall penalty due to a speculative conflict thread can be easily covered by another thread.

In exemplary embodiments, also, instruction reordering in a thread and thread out-of ordering in a task, such as a more flexible instruction level or thread level flow control, are provided.

Separate instructions such as a speculative conflict load/store instruction, e.g., an ALU instruction and so on, may be executed prior to an actual load operation until a speculative conflict load/store instruction is reissued from a standby buffer. This may enable an execution latency of each thread to be shortened. The thread dispatch unit performs out-of ordering of threads, which are to be issued in the future, using speculative conflict detection information. Thus, future conflict misses may be prevented in a thread dispatching step. This makes it possible to reduce execution latency of each task. This may correspond to the case that each task is formed of multiple threads.

In the system shown in FIG. 12, based on speculative conflict information, the GPU 100 controls threads or performs a load/store pipeline operation without a reduction in performance.

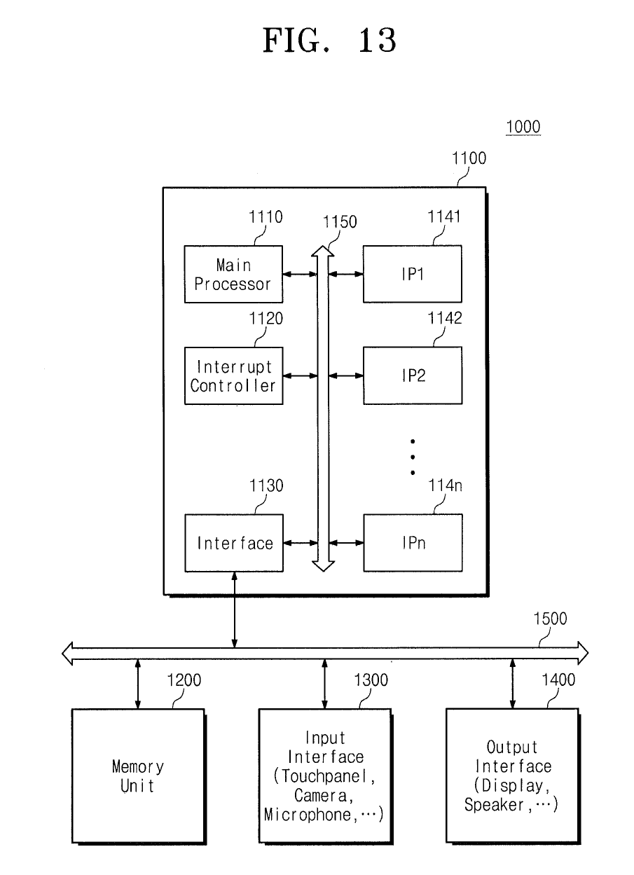

FIG. 13 is a block diagram schematically illustrating an application applied to a multimedia device 1000, in accordance with embodiments of the present inventive concepts.

Referring to FIG. 13, the multimedia device 1000 includes an application processor 1100, a memory unit 1200, an input interface 1300, an output interface 1400, and a bus 1500.

The application processor 1100 is configured to control an overall operation of the multimedia device 1000. The application processor 1100 may be implemented with a system-on-chip, or otherwise formed of a system-on-chip.

The application processor 1100 encompasses a main processor 1110, an interrupt controller 1120, an interface 1130, a plurality of intellectual properties 1141 to 114n, and an internal bus 1150.

The main processor 1110 may include a core of an application processor. The interrupt controller 1120 manages interrupts issued from components of the application processor 1100 and reports them to the main processor 1110.

The interface 1130 processes communications between the application processor 1100 and external components. The interface 1130 may enable the application processor 1100 to control external components. The interface 1130 may include, but not limited to, an interface controlling the memory unit 1200 and an interface controlling the input interface 1300 and the output interface 1400.

The interface 1130 may include, but not limited to, JTAG (Joint Test Action Group) interface, TIC (Test Interface Controller) interface, memory interface, IDE (Integrated Drive Electronics) interface, USB (Universal Serial Bus) interface, SPI (Serial Peripheral Interface), audio interface, and video interface.

The intellectual properties 1141 to 114n are configured for specific functions. For example, the intellectual properties 1141 to 114n may include, but not limited to, an internal memory, a graphics processing unit (GPU), a modem, a sound controller, and a security modem.

The internal bus 1150 is configured to provide a channel among internal components of the application processor 1100. For example, the internal bus 1150 may include an AMBA (Advanced Microcontroller Bus Architecture) bus. The internal bus 1150 may include an AMBA high-speed bus (AHB) or an AMBA peripheral bus (APB).

The main processor 1100 and the intellectual properties 1141 to 114n may include one or more internal memories. Image data can be interleaved and stored in one or more of the internal memories.

The image data may be interleaved and stored in the memory unit 1200 that functions as an internal memory or an external memory of the application processor 1100.

The memory unit 1200 is configured to communicate with other components of the multimedia device 1000 via the bus 1500. The memory unit 1200 may store data processed by the application processor 1100.

The user interface 1300 includes a variety of devices that receive signals from an external device. The user interface 1300 may include, but not limited to one or more of a keyboard, a keypad, a button, a touch panel, a touch screen, a touch pad, a touch ball, a camera including an image sensor, a microphone, a gyroscope sensor, a vibration sensor, a data port for a wire input, and an antenna for a wireless input.

The output interface 1400 includes a variety of devices that output signals to an external device. The user interface 1400 includes an LCD, an OLED (Organic Light Emitting Diode) display device, an AMOLED (Active Matrix OLED) display device, an LED, a speaker, a motor, a data port for a wire output, and an antenna for a wireless output.

The multimedia device 1000 may automatically edit an image captured via an image sensor of an input interface 1300, and display the edited result via a display unit of the output interface 1400. The multimedia device 1000 is constructed and arranged to be specialized for an image conference and provides an image conference service with improved quality of service (QoS).

The multimedia device 1000 may be a mobile multimedia device, such as, but not limited to, a smart phone, a smart pad, a digital camera, or a notebook computer or a fixed multimedia device, such as, but not limited to, a smart television or a desktop computer.

In some embodiments, the application processor 1100 may be connected to a GPU 100 of FIG. 2 or may include a GPU 100 of FIG. 2. Thus, since a miss rate at cache accessing is reduced, performance of multimedia data processing is improved. Also, processing performance of the GPU is improved through power, energy and latency saving.

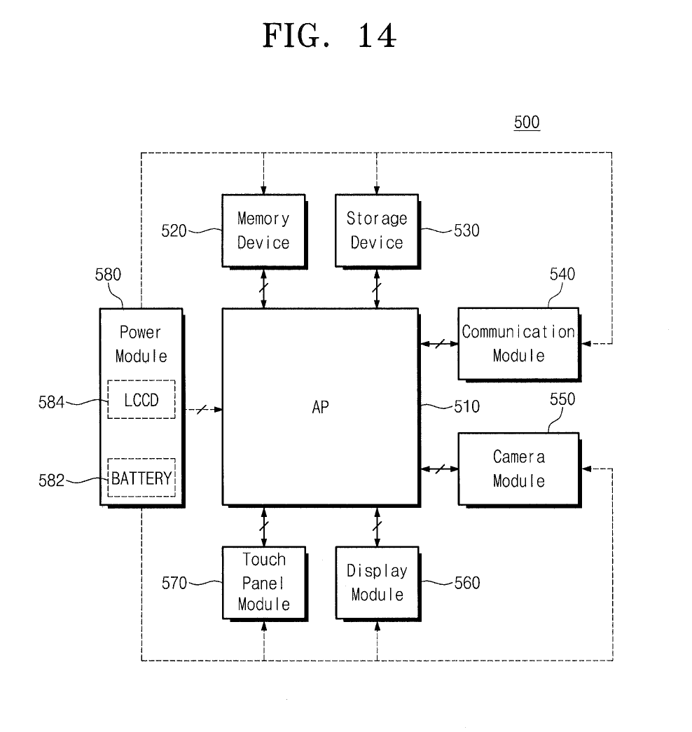

FIG. 14 is a block diagram schematically illustrating an application applied to a mobile device, in accordance with some embodiments of the present inventive concepts.

Referring to FIG. 14, a mobile device that functions as a smart phone includes an AP 510, a memory device 520, a storage device 530, a communication module 540, a camera module 550, a display module 560, a touch panel module 570, and a power module 580.

The AP 510 is connected to a GPU 100 of FIG. 2, or may include a GPU 100 of FIG. 2. Thus, since a miss rate at cache accessing is reduced by using speculative conflict information, performance of multimedia data processing is improved. Also, processing performance of the AP 510 is improved through power, energy and latency reductions.

The communication module 540 is connected to the AP 510 and can act as a modem or the like configured to perform a communication data transmitting and receiving function and a data modulating and demodulating function.

The storage device 530 may include a NOR or NAND flash memory to store mass information.

The display module 560 is implemented with a liquid crystal having a backlight, a liquid crystal having an LED light source, or a touch screen (e.g., OLED). The display module 560 may be an output device for displaying images, for example, characters, numbers, pictures, etc. in color.

The touch panel module 570 provides the AP 510 with a touch input solely or together with the display module 560.

There is described an embodiment in which the mobile device is a mobile communications device. In some cases, the mobile device may be used as a smart card by adding or removing components to or from the mobile device.

The mobile device may be connected with an external communication device via a separate interface. The mobile device may be a DVD player, a computer, a set top box (STB), a game machine, a digital camcorder, or related electronic devices.

The power module 580 performs power management of the mobile device. As a result, power saving of the mobile device can be achieved if a PMIC scheme according to embodiments herewith is applied to a system-on-chip.

The camera module 550 includes a camera image processor (CIS) and is connected to the AP 510.

Although not shown in FIG. 14, the mobile device can further comprise other application chipsets or a mobile DRAM.

FIG, 15 is a block diagram schematically of a computing device, in accordance with embodiments of the present inventive concepts.

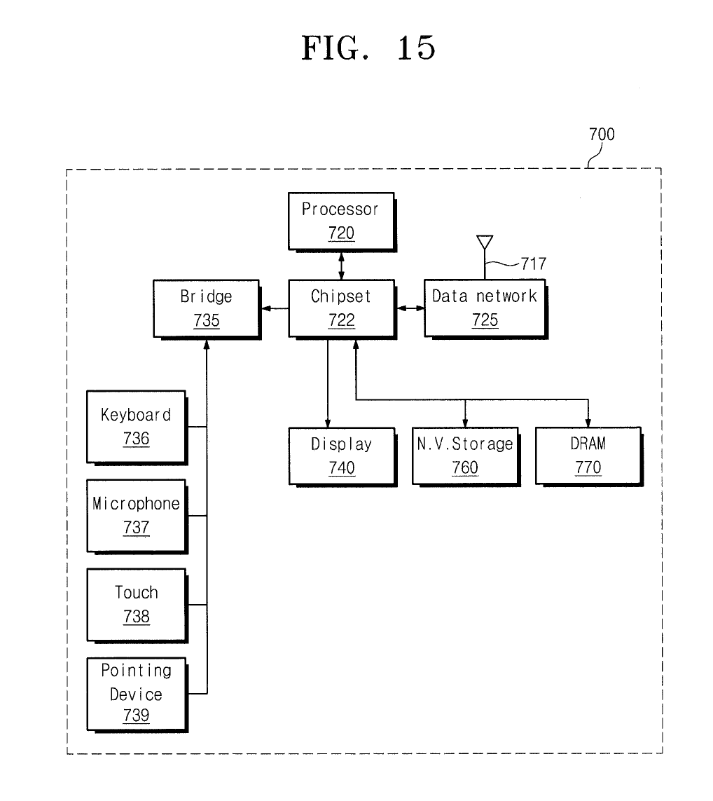

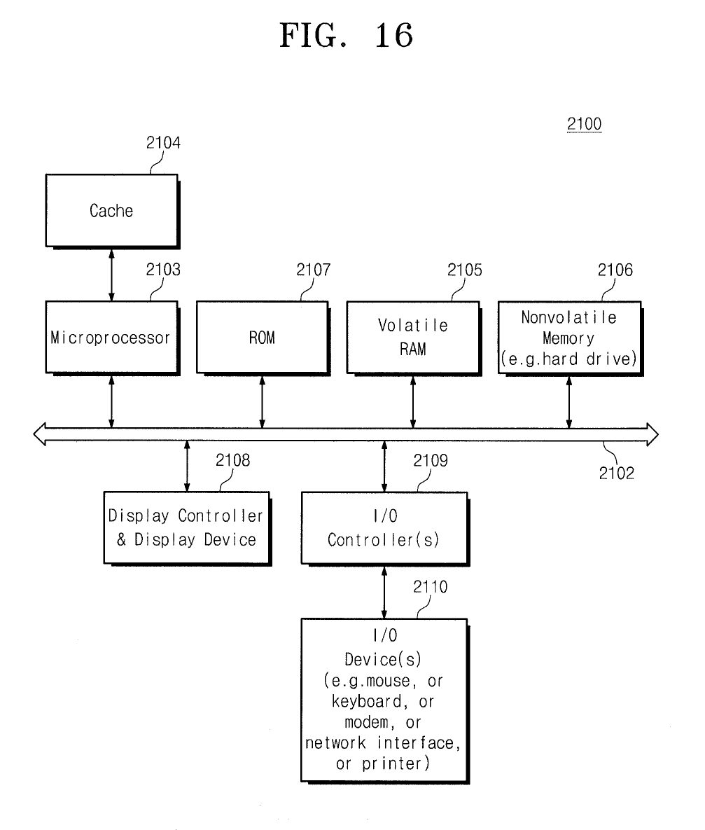

Referring to FIG. 15, the computing device 700 includes a processor 720, a chipset 722, a data network 725, a bridge 735, a display 740, storage 760, a DRAM 770, a keyboard 736, a microphone 737, a touch unit 738, and a pointing device 739.

The chipset 722 provides the DRAM 770 with a command, an address, data, or other control signals.

The processor 720 acts as a host and controls an overall operation of the computing device 700.

The processor 720 may be connected to a GPU 100 of FIG. 2 or may include a GPU 100 of FIG. 2. Thus, since a miss rate at cache accessing is reduced by using speculative conflict information, performance of multimedia data processing is improved. Also, processing performance of the computing device is improved through power, energy and latency reductions.

An interface between the processor 720 and the chipset 722 may be implemented using a variety of protocols for data communications. The chipset 722 communicates with a host or an external device through at least one of various interface protocols, such as USB (Universal Serial Bus) protocol, MMC (multimedia card) protocol, PCI (peripheral component interconnection) protocol, PCI-E (PCI-express) protocol, ATA (Advanced Technology Attachment) protocol, serial-ATA protocol, parallel-ATA protocol, SCSI (small computer small interface) protocol, ESDI (enhanced small disk interface) protocol, and IDE (Integrated Drive Electronics) protocol.

The device shown in FIG. 15 may be provided as one of various components of an electronic device, such as a computer, a ultra-mobile personal computer (UMPC), a workstation, a net-book, a personal digital assistance (PDA), a portable computer (PC), a web tablet, a wireless phone, a mobile phone, a smart phone, a smart television, a three-dimensional television, an e-book, a portable multimedia player (PMP), a portable game console, a navigation device, a black box, a digital camera, a digital multimedia broadcasting (DMB) player, a digital audio recorder, a digital audio player, a digital picture recorder, a digital picture player, a digital video recorder, a digital video player, a device for transmitting and receiving information in a wireless environment, one of various electronic devices constituting a home network, one of various electronic devices constituting a computer network, one of various electronic devices constituting a telematics network, a radio frequency identification (RFID) device, or one of various components constituting a computing system.

FIG. 16 is a block diagram of a digital processing system, in accordance with embodiments of the present inventive concepts.

Referring to FIG. 16, the digital processing system 2100 includes a microprocessor 2103, a ROM 2107, a volatile RAM 2105, a nonvolatile memory 2106, a display controller and display device 2108, an I/O controller 2109, an I/O device 2110, a cache 2104, and a bus 2102.

The microprocessor 2103 controls an overall operation of the digital processing system according to a predetermined program.

The microprocessor 2103 can be connected to a GPU 100 of FIG. 2 or may include a GPU 100 of FIG. 2. Thus, since a miss rate at cache accessing is reduced, performance of multimedia data processing is improved. Also, processing performance of a system is improved through power, energy and latency saving.

The volatile RAM 2105 is connected to the microprocessor 2103 via a bus 2102 and acts as a buffer memory or a main memory of the microprocessor 2103.

The digital processing system 2100 may be connected with an external communication device via a separate interface. The digital processing system may be a DVD player, a computer, a set top box (STB), a game machine, a digital camcorder, or the like.

A volatile RAM (2105) chip or a nonvolatile memory (2106) chip according to the inventive concept may be packaged according to any of a variety of different packaging technologies. Examples of such packaging technologies may include PoP (Package on Package), Ball grid arrays (BGAs), Chip scale packages (CSPs), Plastic Leaded Chip Carrier (PLCC), Plastic Dual In-Line Package (PDIP), Die in Waffle Pack, Die in Wafer Form, Chip On Board (COB), Ceramic Dual In Line Package (CERDIP), Plastic Metric Quad Flat Pack (MQFP), Small Outline (SOIC), Shrink Small Outline Package (SSOP), Thin Small Outline (TSOP), Thin Quad Flatpack (TQFP), System In Package (SIP), Multi Chip Package (MCP), Wafer-level Fabricated Package (WFP), Wafer-Level Processed Stack Package (WSP), and the like.

The nonvolatile memory 2106 may store data information having various data formats such as text, graphic, software code, and so on.

The nonvolatile memory 2106, for example, may be implemented with EEPROM (Electrically Erasable Programmable Read-Only Memory), flash memory, MRAM (Magnetic RAM), Spin-Transfer Torque MRAM, Conductive bridging RAM (CBRAM), FeRAM (Ferroelectric RAM), PRAM (Phase change RAM) called OUM (Ovonic Unified Memory), Resistive RAM (RRAM or ReRAM), Nanotube RRAM, Polymer RAM (PoRAM), Nano Floating Gate Memory (NFGM), holographic memory, Molecular Electronics Memory Device, or Insulator Resistance Change Memory.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative. For example, there is described an example in which a memory controller performs write leveling. In some cases, changes or modification on an operation or a detail of a load/store pipeline unit may be made by changing circuit components of drawings or adding or subtracting components without departing from the spirit and scope of the inventive concept. Also, a data processing system including GPU is mainly described. However, the inventive concept is applicable to, but not limited to, other data processing systems using a cache memory.

What is claimed is:

1. A multimedia data processing method comprising:
providing a conflict detection unit at a load/store pipeline unit;
generating, by the conflict detection unit, speculative conflict information, which is used to predictively determine whether an address of a load/store instruction of a current thread causes a conflict miss before a cache access operation is performed by a history search for load/store instruction addresses of previous threads without referring to a cache memory; and
storing information of the current thread directly in a standby buffer without an execution of the cache access operation in response to the generated speculative conflict information indicating the conflict miss.

2. The multimedia data processing method of claim 1, wherein the speculative conflict information is generated in response to associative information of the cache memory and a given time window of the history search.

3. The multimedia data processing method of claim 1, wherein the speculative conflict information is generated by comparing an address of the load/store instruction of the current thread with an address of the load/store instruction of the previous threads obtained from the history search.

4. The multimedia data processing method of claim 3, wherein the addresses of the load/store instructions of the previous threads include index information and tag information, and wherein the index and tag information of the addresses is stored in a register for the history search in a history file form during a user-defined time interval.

5. The multimedia data processing method of claim 1, wherein the speculative conflict information is generated prior to an access operation of a cache tag memory for detection of an actual conflict miss, and wherein the method further comprises:
comparing an address of a load/store instruction of a current thread with an address of a load/store instruction of the previous threads obtained from the history search;
counting addresses that have the same index as the load/store instruction of the current thread and that exist in addresses of load/store instructions of the previous threads, wherein in response to a determination that the indexes of the addresses are equal to one another, the method further comprises:
increasing a count value when a tag of the current address is determined to be different from each other in relation to tags of the previous addresses; and
and performing an invalid counting operation when the tag of the current address is equal to a tag of a previous address; and
determining a generation of the speculative conflict information when a counting result value exceeds a given associative value of the cache memory.

6. The multimedia data processing method of claim 1, wherein when the address of the load/store instruction of the current thread is determined to be a virtual address, the speculative conflict information is detected at the beginning of the load/store pipeline unit prior to a detection of an actual conflict miss.

7. The multimedia data processing method of claim 1, wherein the speculative conflict information is provided to a thread dispatcher of a graphics processing unit (GPU) to control a thread level flow.

8. A multimedia data processing system comprising:
a load/store pipeline unit including:
a conflict detection unit that generates speculative conflict information that predictively indicates whether a current load/store instruction causes a conflict with respect to previously issued load/store instructions prior to a cache memory access operation is performed;
a standby buffer that temporarily stores missed threads upon a generation of a cache miss operation; and
a cache memory that stores data for load/store pipeline processing; and
a thread control unit that performs a flexible thread level flow control using the speculative conflict information generated by the conflict detection unit.

9. The multimedia data processing system of claim 8, wherein when the conflict detection unit sets a speculative conflict detection to an ON mode, the thread control unit controls an out-of ordering of threads to be issued in the future using the speculative conflict information.

10. The multimedia data processing system of claim 8, wherein when the speculative conflict information is generated, the load/store pipeline unit does not perform subsequent operations including a cache access operation, a data request operation, and a cache replace operation to prevent a future conflict miss.

11. The multimedia data processing system of claim 8, wherein the conflict detection unit compares an address of a load/store instruction of a current thread with addresses of load/store instructions of previous threads obtained from a register for a history search.

12. The multimedia data processing system of claim 11, wherein in response to comparing the address of the load/store instruction of the current thread with the addresses of the load/store instructions of the previous threads, the conflict detection unit counts addresses that have the same index as the address of the load/store instruction of the current thread and exist in addresses of load/store instructions of previous threads, and wherein a determination is made that if the indexes of the addresses are equal to one another, then the conflict detection unit increases a count value when tags of the current previous addresses, respectively, are determined to be different from each other, the conflict detection unit performs an invalid counting operation when the tag of the current address is equal to a tag of a previous address, and the conflict detection unit generates the speculative conflict information when a counting result value exceeds a given associative value of the cache memory.

13. The multimedia data processing system of claim 8, further comprising:
an address generation unit that converts a virtual address of a load/store instruction of a current thread into a physical address and provides the physical address to the conflict detection unit.

14. The multimedia data processing system of claim 8, wherein the conflict detection unit operates selectively according to a user control or a hardware control.

15. The multimedia data processing system of claim 8, wherein the system is formed of a system-on-chip.

16. A pipeline unit of a graphics processor comprising:
a conflict detection unit that generates speculative conflict information for predictively determining whether an address of a load/store instruction of a current thread causes a conflict miss before a cache access operation is performed; and
a standby buffer that stores information related to the current thread absent an execution of the cache access operation in response to the generated speculative conflict information.

17. The pipeline unit of claim 16, further comprising a register that stores previous load/store instructions.

18. The pipeline unit of claim 17, wherein the conflict detection unit generates the speculative conflict information by comparing an address of the current load/store instruction with addresses of the previous load/store instructions stored in the register.

19. The pipeline unit of claim 16, wherein the conflict detection unit sets a speculative conflict detection to an ON mode, and, in response, the conflict detect unit communicates with a thread control unit which controls an out-of ordering of threads to be issued in the future using the speculative conflict information.

20. The pipeline unit of claim 16, wherein the speculative conflict information is used for predictively determining whether the address of the load/store instruction of the current thread causes a conflict miss before the cache access operation is performed by a history search for load/store instruction addresses of previous threads without referring to a cache memory.
